(19) United States
(12) Patent Application Publication
(10) Pub. No.: US 2003/0175397 A1
(43) Pub. Date: Sep. 18, 2003

(54) Dough intermediate

(76) Inventors: Dennis A. Lonergan, Medina, MN (US); Douglas Lee Goedeken, Blaine, MN (US); Rosebud L. Sierzant, Minneapolis, MN (US); Janet Lynne Boyle, Saint Paul, MN (US)

Correspondence Address: GENERAL MILLS, INC., P.O. BOX 1113, MINNEAPOLIS, MN, 55440, US

(21) Appl. No.: 10/100,427

(22) Filed: Mar. 18, 2002

(51) Int. Cl. A21D 10/00

(52) U.S. Cl. 426/549

(57) ABSTRACT

The present invention pertains to a dough intermediate that is subject to a further processing step by an end user and that has a uniform average air cell size. Through the use of an average air cell size and void fraction volume, a dough intermediate can be produced without the use of chemical leavening agents.

### CROSS-REFERENCES TO RELATED APPLICATIONS

None.

### BACKGROUND AND SUMMARY OF THE INVENTION

The present invention relates to a dough intermediate, which is intended to undergo at least one further processing step, such as heating or baking, by the end user prior to consumption. More particularly, the present invention relates to a dough intermediate which is prepared without the use of chemical leavening agents and which has a specific void fraction and a minimum air cell size.

The availability of convenient to prepare food items or products that may be ready to eat upon purchase, continue to increasingly permeate our society as the level of on the go consumers increases due to demands of jobs and family life. However, while society continues to move at an ever increasingly rapid rate, there still remains a desire to add a personal or “homey” touch, or to see some personal addition to the product that fulfills the desire of caring either for one's family or for oneself.

Many commercial manufacturers try to replicate the types of products that one would make from scratch in one's home or purchase from a local bakery in order to create a retail package or product, which would have similar characteristics to those products. Unfortunately however, with mass production unwanted characteristics such as flavors or textures can creep into the product, defeating the goal of the manufacturer.

The dough products and dough intermediates produced by commercial manufacturers are made and shaped by various conventional processes and then placed on trays, pallets, plates, pans, skids and other devices, collectively referred to herein as “appliances”, created for the convenience of the manufacturer so that they may be transported through the processing operation. The processing operation may

### CROSS-REFERENCES TO RELATED APPLICATIONS

None.

### BACKGROUND AND SUMMARY OF THE INVENTION

The present invention relates to a dough intermediate, which is intended to undergo at least one further processing step, such as heating or baking, by the end user prior to consumption. More particularly, the present invention relates to a dough intermediate which is prepared without the use of chemical leavening agents and which has a specific void fraction and a minimum air cell size.

The availability of convenient to prepare food items or products that may be ready to eat upon purchase, continue to increasingly permeate our society as the level of on the go consumers increases due to demands of jobs and family life. However, while society continues to move at an ever increasingly rapid rate, there still remains a desire to add a personal or “homey” touch, or to see some personal addition to the product that fulfills the desire of caring either for one's family or for oneself.

Many commercial manufacturers try to replicate the types of products that one would make from scratch in one's home or purchase from a local bakery in order to create a retail package or product, which would have similar characteristics to those products. Unfortunately however, with mass production unwanted characteristics such as flavors or textures can creep into the product, defeating the goal of the manufacturer.

The dough products and dough intermediates produced by commercial manufacturers are made and shaped by various conventional processes and then placed on trays, pallets, plates, pans, skids and other devices, collectively referred to herein as “appliances”, created for the convenience of the manufacturer so that they may be transported through the processing operation. The processing operation may include baking, cutting, sorting, packing, icing, filling and various other processing steps in order to produce the anticipated end product.

There are a number of products, including dough based products in the marketplace today, which can be taken directly from the freezer case in the retail outlet or from one's home freezer to the oven and even to the microwave oven for final preparation or heating prior to consumption. While the use of microwave ovens has increased over time, the use is primarily directed to heating or thawing products for subsequent consumption. Some of today's freezer-based products are capable of undergoing some level of final cooking or preparation that fulfills the needs of consumers set forth above, that is, adding a cooking, baking or browning step to the meal to be served. However, with the speed and convenience associated with microwave ovens, difficulties and other problems have arisen in order for the manufacture to replicate the desired qualities if a conventional oven were used.

One of the problems associated with dough based products that are taken directly from the freezer and placed in the microwave oven for final cooking is that in order to obtain an aesthetically pleasing and palatable product, the dough product is prepared or mixed using chemical leavening agents. Chemical leavening agents are relatively well known and include SAPP (sodium aluminum pyrophosphates), which is a fast acting chemical leavening agent, SALP (sodium aluminum phosphate) which is slow acting chemical agent, DCP (dicalcium phosphate), MCP (monocalcium phosphate monohydrate), SAS (sodium aluminum sulfate), potassium hydrogen tartrate (cream of tartar), and combinations thereof, and the like.

While the use of such chemical based leavening agents in dough intermediates is intended to permit the product to rise and bake evenly, due to the short duration of time in which the dough intermediate is exposed to the microwave energy, the chemical leavening agent does not have time to react and as such the dough product can acquire undesirable flavors or even textures due to the incomplete reaction of the leaveners in the dough product.

If however, chemical leaveners are eliminated from the dough intermediate during the mixing or manufacturing process, the dough intermediate after exposure to microwave energy may exhibit large blisters, bubbling or other unappealing characteristics on the outer surface, creating a displeasing image (that the product is defective or spoiled) in the mind of the consumer.

What is therefore needed is a dough intermediate which overcomes the foregoing difficulties such as the unpleasant taste or appearance created when chemical leaveners are used in a product that is subsequently subjected to microwave energy.

Surprisingly and unexpectedly, it has been discovered that by creating a substantially uniform cellular matrix throughout the dough intermediate, the use of chemical leaveners can substantially be avoided, and the resulting product that is created is one that is pleasing both aesthetically as well as palatable to the end user.

In a preferred embodiment of the present invention, a dough intermediate, is produced from at least a mixture of flour, yeast and water. The resulting dough intermediate has a minimum air cell size ranging from about 90 microns to about 220 microns.

In a still further embodiment of the present invention, a dough intermediate is described and includes a dough produced from at least a combination of yeast, flour and water and substantially without a chemical leavening agent. The dough intermediate that is produced has a cellular matrix ranging from about 14% to around 45% of said dough.

This and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a plan view of a dough intermediate according to the present invention in which a cut away portion is illustrated;

FIG. 2 is a photograph showing a dough intermediate a particular ratio of preferment to proof;

FIG. 3 is a photograph shows a further illustration of a dough intermediate a particular ratio of preferment to proof; and

FIG. 4 is a photograph shows a still further illustration of a dough intermediate a particular ratio of preferment to proof.

### DETAILED DESCRIPTION OF THE INVENTION

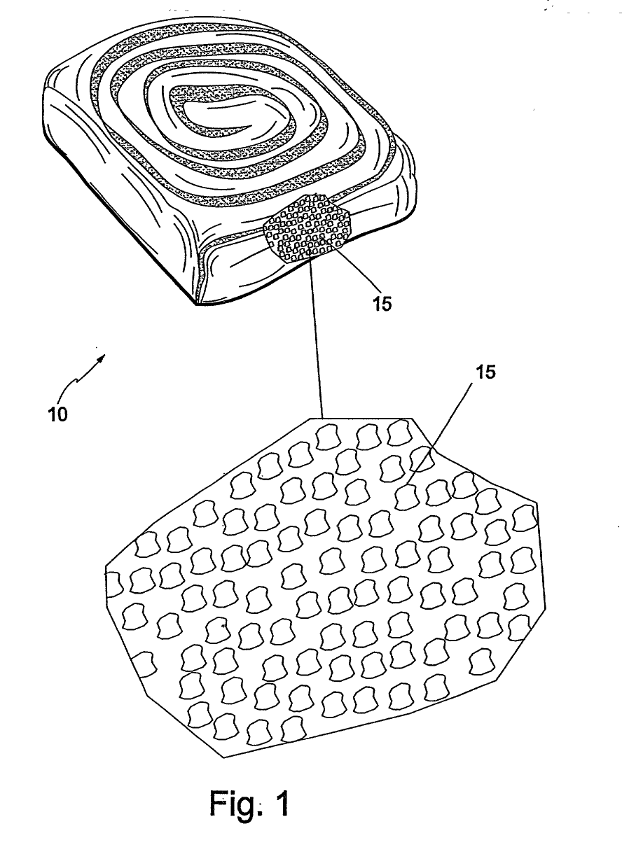

Turning to FIG. 1 of the present invention, the dough intermediate generally designated as 10 illustrates the dough intermediate in its final rolled, sliced state (having been cut from a larger roll of layered dough—not shown) with an enlarged cut away showing the substantially regular cellular matrix or structure 15 of the present invention.

As used herein, the term dough intermediate refers to dough-based products, such as rolls, biscuits, buns, cinnamon rolls or buns, croissants, pastries and the like which undergo a further processing step by the end user, such as baking or heating.

The following table sets forth a suggested formula for use in practicing the present invention.

| IS # | INGREDIENT | CHEMIST | BAKER |
|---|---|---|---|
| 16044 | Biscuit Flour | 53.53 | 100.00 |
| 11659 | WATER | 23.27 | 43.48 |
| 15905 | Gluten | 0.00 | 0.00 |
| | Dough Conditioner | 0.30 | 0.56 |
| 18206 | Salt | 1.00 | 1.87 |
| 18940 | PHVO | 8.00 | 14.95 |
| 15311 | Vanilla Flavor | 0.40 | 0.75 |
| 19611 | Compressed yeast | 5.00 | 9.34 |
| 19202 | Sucrose | 5.00 | 11.21 |
| 16813 | Sweet Whey Solids | 1.00 | 1.87 |
| 12203 | Monoglycerides | 1.50 | 2.80 |
| | RGB Color Solution | 0.10 | 0.19 |
| | TOTAL % | 100.00 | 186.82 |

To create the dough of the present invention, water, yeast, monoglycerides and a color solution (if necessary) are first combined and then all the remaining dry ingredients are placed in a bowl. The mixture is mixed on a low speed for about 60 seconds and then on a higher speed for about 8 minutes.

After the mixing is completed, the dough is allowed to rest for about thirty minutes at room temperature and is kept covered to prevent the dough from loosing moisture during the drying step.

The dough is then removed and sheeted to an approximate thickness of about 3 mm. Next, the filling, as described below, is applied to the sheeted dough and the dough is then rolled upon itself to create a number of layers or swirls. In the present embodiment, 7 layers or swirls are created. The roll has a diameter of approximately 5 centimeters, a height of 4 to 5 centimeters and a weight of approximately 100 to 110 grams. The rolls are then sliced into approximately 1-inch pieces and packaged for freezing.

In order to obtain the desired browning in the microwave oven, a browning solution is applied, such as Maillose. In a preferred embodiment of the present invention a solution of Maillose, soy protein isolate and water is prepared and applied to the dough intermediate. The amount of Maillose ranges from 10 to 30% by weight of the solution.

Occasionally, it may be necessary to use a dough conditioner as part of the manufacture of the dough. The formula for the dough conditioner is as follows:

| | | % |
|---|---|---|
| Dough | Conditioner Preblend | Dough |
| 12218 | DATEM w/amylase | 0.175 |
| 11546 | Ascorbic Acid | 0.005 |
| 11614 | SSL | 0.12 |

The filling of the preferred embodiment of the present invention is as follows:

| | % Filling |
|---|---|
| Brown Sugar, Powder | 27.15 |
| Shortening | 35.00 |
| Sucrose | 14.90 |
| Milk Product | 3.95 |
| Cinnamon | 5.00 |
| Alginate | 0.75 |
| Water | 10.00 |
| HF Corn Syrup | 15.00 |
| Albumin | 1.15 |
| Wheat Starch | 4.00 |
| Total: | 116.90 |

The filling was prepared by first melting the margarine. Next, the sugar, cinnamon, milk product, starch and albumin are dry blended together. Finally, the sugar combination is mixed with the melted margarine using a Kitchen Aid®, available from Kitchen Aid, Inc. St. Joseph, Mich., mixer on a low speed. The water and corn syrup are added and the mixture is mixed on a medium speed until fully blended.

In the preferred embodiment of the present invention, it is important to obtain the necessary cellular structure prior to the dough intermediate being frozen. This will provide the dough intermediate with acceptable baking and volume properties upon exposure to microwave energy. Preferably, a dough intermediate is created having a void fraction of at least 15% of the product and a minimum air cell size of approximately 125 microns in diameter.

As used herein, the term “void fraction” refers to the volume fraction of dough occupied by air rather than the gluten/starch matrix in the dough. For example, if a dough has a volume of 100 cc, and of that volume, 40 cc is occupied by air, the void fraction would be 40/100 which would be 0.4. The void fraction can be measured from micrographs, or estimated using a measure of the total volume of the sample combined with the approximation that the density of air free dough is 1.2 g/cc (specific volume 0.83 cc/gr). That is, if a 100 gm sample of dough has a volume of 150 cc, the volume of air free dough is estimated to be (0.83 gm/cc×100=83 cc). Thus, the volume occupied by air would be 67 cc and the void fraction would be 67/150=0.44.

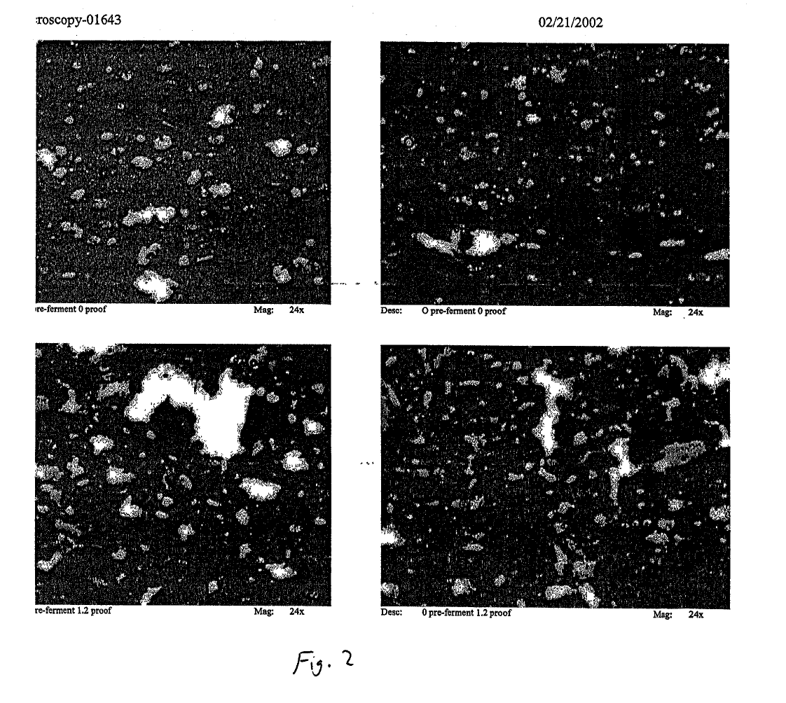

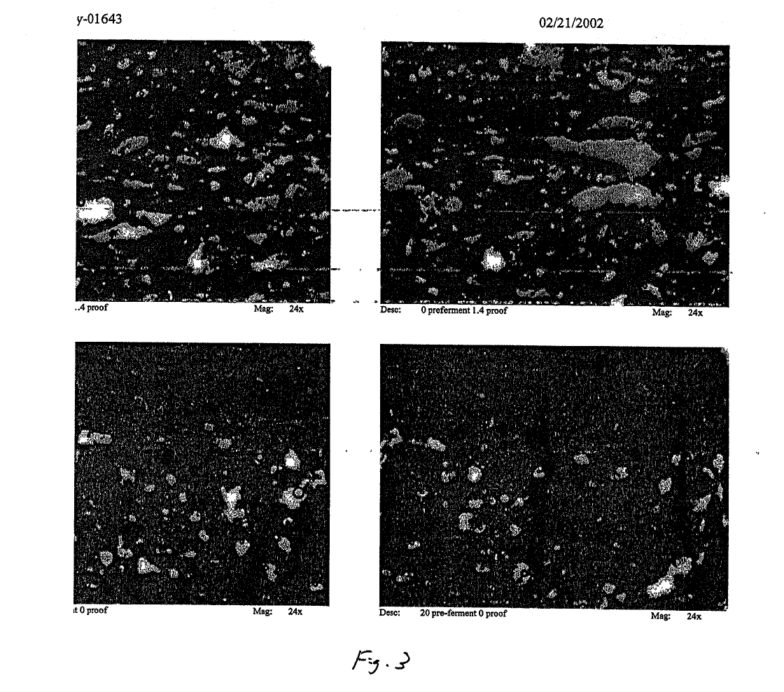

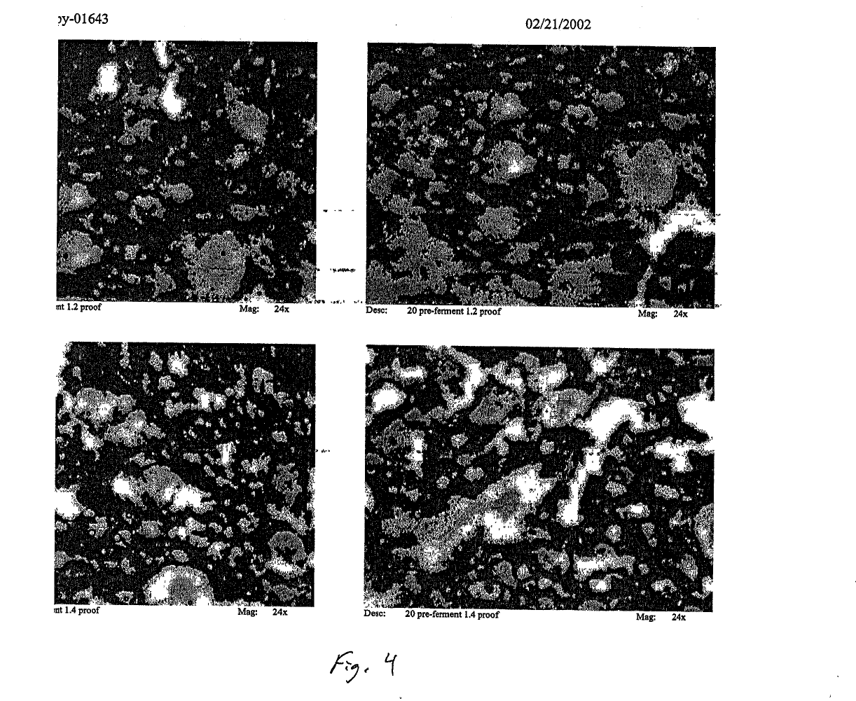

As can been seed from the following table, the air cell size of the dough ranges from about 90 microns to around 220 microns and more preferably about 120 microns to about 190 microns with about 125 microns to about 150 microns being the optimal preferred sized for the air cells or bubble in the dough intermediate. The particular cells are illustrated in FIG. 2 through FIG. 4.

Image Analysis of Bubble Size Distribution Feb. 18, 2002

| | | Ave. Eq. |
|---|---|---|
| Pre-ferment/Proof | % Bubbles | Circular Diameter |
| 0-0 | 8.7 | 110.9 |
| | 6.3 | 92.4 |
| Average | 7.5 | 101.7 |
| 0-1.2 | 11.8 | 125.9 |
| | 14.5 | 120.2 |
| Average | 13.2 | 123.1 |
| 0-1.4 | 17.3 | 130.4 |
| | 15.8 | 128.5 |
| | 16.6 | 129.5 |
| 20-0 | 7.5 | 104.4 |
| | 5.5 | 103.5 |
| Average | 6.5 | 104.0 |
| 20-1.2 | 20.6 | 147.3 |
| | 29.7 | 160.8 |
| Average | 25.2 | 154.1 |
| 20-1.4 | 36.5 | 169.6 |
| | 44.8 | 210.4 |
| Average | 40.7 | 190.0 |

The foregoing cellular structure is obtained through the use of a liquid preferment, increasing the normal dough rest time after the dough has been created and/or subsequent proofing after the rolls have been formed.

The data in the table also provides that so long as the percent of cellular matrix in the dough was above roughly 14%, then no blistering of the dough was seen after subjecting the dough intermediate to microwave energy. See the data sets collected for 20-1.4, 20-1.2 and 0-1.4 listed above. In addition, the dough intermediate of the present invention has a cellular matrix ranging from about 14 to 45% of the dough and more preferably around 20 to 30%.

It will thus be seen according to the present invention a highly advantageous dough intermediate has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A dough intermediate, comprising;
an dough intermediate made from at least a mixture of flour, yeast and water; and
wherein, said intermediate has an air cell size ranging from about 90 microns to about 220 microns.

2. A dough intermediate as recited in claim 1, wherein the air cell size ranges from about 120 microns to about 190 microns.

3. A dough intermediate as recited in claim 1, wherein the air cell size ranges from about 125 microns to about 150 microns.

4. A dough intermediate as recited in claim 1, wherein the intermediate has a substantially regular air cell matrix.

5. A dough intermediate as recited in claim 1, wherein the dough intermediate is made substantially without chemical leavening agents.

6. A dough intermediate, comprising;
a dough produced from at least a combination of yeast, flour and water and substantially without a chemical leavening agent; and
said intermediate having an cellular matrix ranging from about 14% to around 45% of said dough.

7. A dough intermediate as recited in claim 6, wherein the dough intermediate has an average air cell size ranging from about 90 to about 220 micros.

8. A dough intermediate as recited in claim 7, wherein the dough intermediate has a substantially regular air cell matrix.

9. A dough intermediate as recited in claim 6, wherein said dough intermediate is subject to one further processing step by an end user.

10. A dough intermediate as recited in claim 9, wherein said further processing step is application of microwave energy.

11. A dough intermediate as recited in claim 6, wherein said dough intermediate has a void fraction volume ranging from about 0.4 to about 0.44.

12. A dough intermediate as recited in claim 6, wherein said dough intermediate as a void fraction volume of around 0.4.
